(19) United States
(12) Patent Application Publication
(10) Pub. No.: US 2010/0157902 A1
(43) Pub. Date: Jun. 24, 2010

(54) METHOD AND SYSTEM OF PROVIDING MULTIMEDIA SERVICE IN IP NETWORK

(75) Inventors: No Ik PARK, Daejeon-city (KR); Soon Seok Lee, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/643,314

(22) Filed: Dec. 21, 2009

(30) Foreign Application Priority Data
Dec. 22, 2008 (KR) 10-2008-0131175

(51) Int. Cl. H04W 4/00; G06F 15/16

(52) U.S. Cl. 370/328; 709/229

(57) ABSTRACT

Provided are a method and system of providing a multimedia service in an information provider (IP) network, wherein the method is performed by a system of providing an IP-based mobile service. The method includes: detecting whether a user, who is being provided with the multimedia service, changed from a first terminal to a second terminal; obtaining characteristic information of the second terminal; and providing the multimedia service after changing the multimedia service according to the obtained characteristic information. When only a terminal changes and an access network does not change, or when only an access network changes and a terminal does not change, a network automatically recognizes characteristics of the terminal and the access network and automatically changes media according to the recognized characteristics. Accordingly, a multimedia service without quality deterioration is received, and moreover, a service that can satisfy characteristics (capacity, size of display, etc.) of a terminal of a user and a corresponding service level agreement (SLA) of the user are provided in various terminal environments.

### CROSS-REFERENCE TO RELATED PATENT APPLICATION

This application claims the benefit of Korean Patent Application No. 10-2008-0131175, filed on Dec. 22, 2008, in the Korean Intellectual Property Office, the disclosure of which is incorporated herein in its entirety by reference.

### BACKGROUND OF THE INVENTION

1. Field of the Invention

The present invention relates to a method and system of providing a multimedia service without quality deterioration regardless of characteristics of a terminal or of an access network in an information provider (IP)-based mobile environment.

2. Description of the Related Art

As users frequently move, an access environment has rapidly changed to a wireless environment, such as high speed packet access (HSPA), wireless broadband (WiBro), WiFi, or the like. Also, terminals have diversified into lap tops, mobile phones, personal digital assistants (PDAs), etc.

Techniques for continuously providing a service without interruption even when an access network or a terminal changes while a user moves are being suggested. One of the techniques includes information provider multimedia subsystem (IMS)-based multimedia session continuity in the 3^{rd} generation partnership project (3GPP). However, these techniques search for a solution about protection between a terminal and another terminal, and between an access network and an access network of a service session that is being used, but are unable to prevent quality deterioration due to a limit of network resources of an access network, characteristics of a terminal, etc. when a service session is protected.

### SUMMARY OF THE INVENTION

The present invention provides a method and system of continuously providing a multimedia service without quality deterioration regardless of changes in characteristics of an access network or a terminal in a mobile environment.

According to an aspect of the present invention, there is provided a method of providing a multimedia service in an information provider (IP) network, wherein the method is performed by a system of providing an IP-based mobile service, the method including: detecting whether a user, who is being provided with the multimedia service, changed from a first terminal to a second terminal; obtaining characteristic information of the second terminal; and providing the multimedia service after transforming the multimedia service according to the obtained characteristic information.

According to another aspect of the present invention, there is provided a method of providing a multimedia service in an IP network, wherein the method is performed by a system of providing an IP-based mobile service, the method including: detecting whether a user, who is being provided with the multimedia service to a terminal via a first access network, is connecting to a second access network; obtaining characteristic information of the terminal and the second access network; and providing the multimedia service by transforming the multimedia service according to the characteristic information.

According to another aspect of the present invention, there is provided a system of providing a multimedia service in an IP-based network, the system including: a terminal which receives the multimedia service; a connecting apparatus which connects the terminal and the IP-based network; and a changing apparatus which, when the terminal or an access network changes, transforms and then provides the multimedia service according to characteristic information of the changed terminal or access network.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual diagram of a network using the present invention;

FIG. 2 is a diagram of a method of providing a service via a connection between an authentication server and a media transforming apparatus while changing a terminal, according to an embodiment of the present invention;

FIG. 3 is a diagram of a method of providing a service via a connection between network equipment and a media transforming apparatus according to a change of an access network, while moving a terminal, according to an embodiment of the present invention; and

FIG. 4 is a diagram of a method of transforming media in a network connecting apparatus while changing a terminal, according to an embodiment of the present invention.

### DETAILED DESCRIPTION OF THE INVENTION

The present invention will now be described more fully with reference to the accompanying drawings, in which exemplary embodiments of the invention are shown.

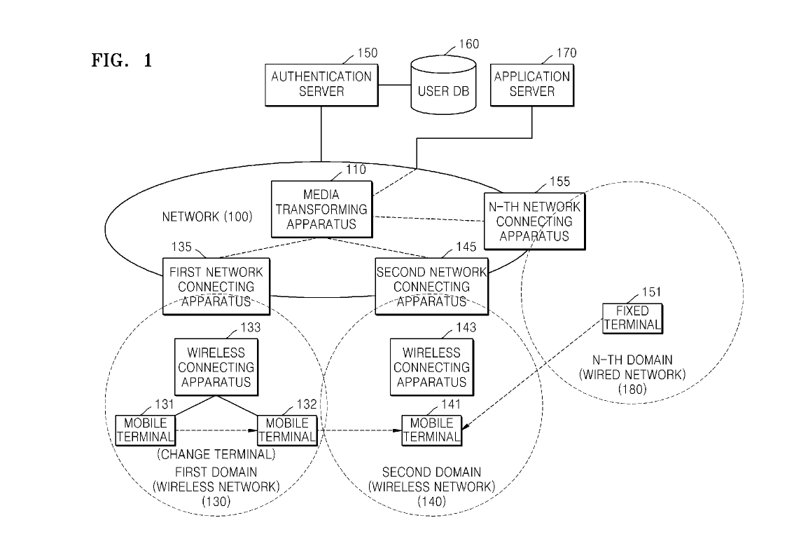

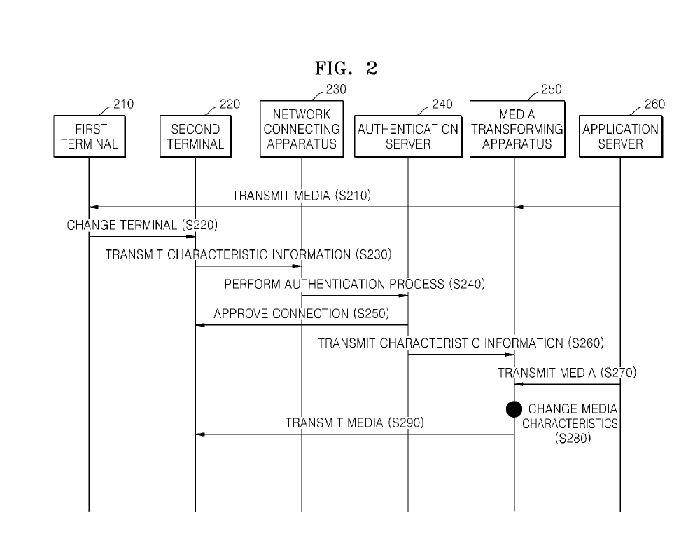

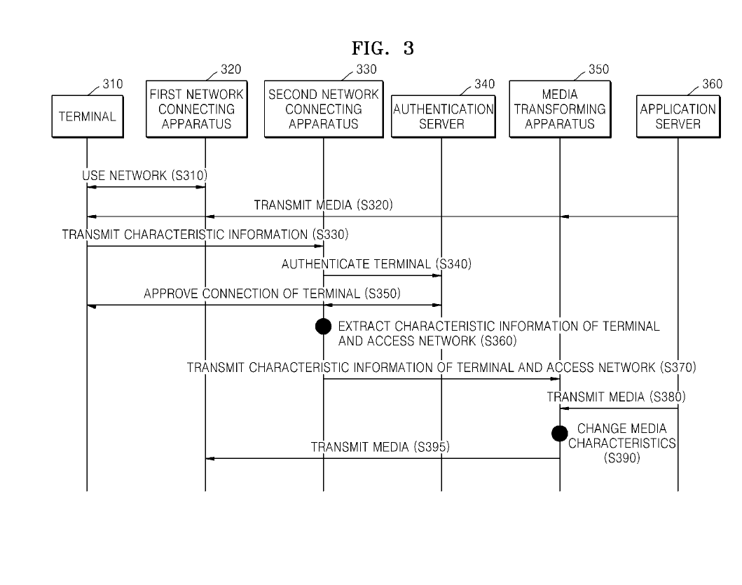

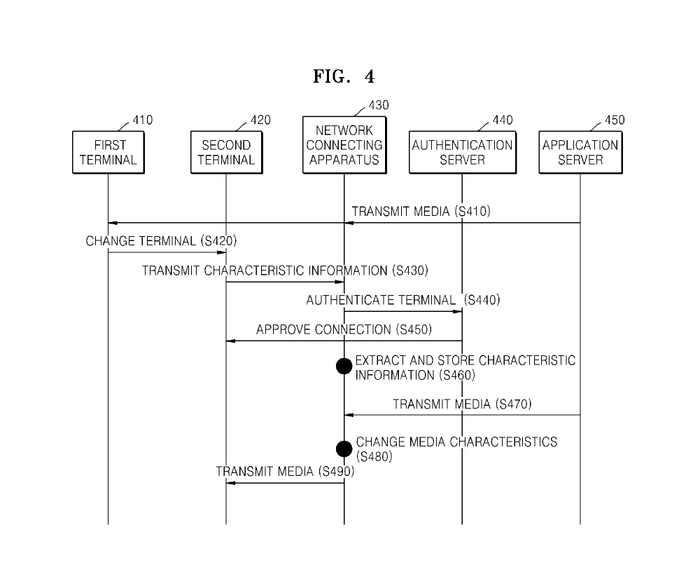

FIG. 1 is a conceptual diagram of a network using the present invention. FIG. 2 is a diagram of a method of providing a service via a connection between an authentication server and a media transforming apparatus while changing a terminal, according to an embodiment of the present invention. FIG. 3 is a diagram of a method of providing a service via a connection between network equipment and a media transforming apparatus according to a change of an access network, while moving a terminal, according to an embodiment of the present invention, and FIG. 4 is a diagram of a method of transforming media in a network connecting apparatus while changing a terminal, according to an embodiment of the present invention.

In order to provide a media service without quality deterioration regardless of a change or movement of a terminal or a change of an access network, a network layer or an application layer needs to automatically detect and determine a status change of a transmission layer including characteristics of the access network or the terminal, and change media characteristics according to the status change of the transmission layer.

FIG. 1 is a conceptual diagram of a network 100 that can provide a media service without quality deterioration while changing or moving a terminal or changing an access network. The network 100 can provide a different service level agreement (SLA)-based service according to each subscriber. The network 100 includes first through n-th network connecting apparatuses 135, 145, and 155, which may be starting points for processing an information provider (IP) packet. When access networks are wireless networks 130 and 140, at least one of wireless connecting apparatuses 133 and 143 is connected to the network connecting apparatus 135 and 145, and a user connects to the network 100 via mobile terminals 131, 132, and 141 which are capable of wireless communication. Also, a network service may be used in a wired network 180 via a fixed terminal 151. Here, the network service may be a service in a client/server form with an application server 170, or a service in an end-to-end communication form between the application server 170 and one of the mobile terminals 131, 132, and 141.

An authentication server 150 and a user database (DB) 160 performs authentication on a network and a service including user information and terminal information of a user. When the user moves, a media transforming apparatus 110 detects a change of characteristics of a transmission layer, wherein the characteristics of the transmission layer includes characteristics of an access network or a terminal, and changes characteristics of media that is already being transmitted, and then transmits the media having the transformed characteristics to a corresponding terminal. Here, the media transforming apparatus 110 determines characteristic information of a changed terminal or a changed access network. The characteristic information of the changed terminal may be determined by connecting the media transforming apparatus 110 to the authentication server 150 by using information stored in the user DB 160, or by connecting the media transforming apparatus 110 to the one of the group consisting of the first through n-th network connecting apparatuses 135, 145, and 155 or other network equipment that has a function of extracting and recording characteristic information of a terminal, so that the media transforming apparatus 100 automatically determines characteristics of a terminal and may change media characteristics. Here, characteristic information of a terminal may be obtained based on an intrinsic identification (ID) including a media access control (MAC) address and an ENUM of the terminal. The first through n-th network connecting apparatuses 135, 145, and 155 may extract and transmit characteristics of an access network to the media transforming apparatus 110, and the media transforming apparatus 110 may automatically transforms media characteristics accordingly.

The media transforming apparatus 110 may include functions of the application server 170, and functions of transmission equipment including separate equipment on a network and the first through n-th network connecting apparatuses 135, 145, and 155.

Characteristics of an access network may include idle resources of the access network or transmission characteristics such as transmission capacity. Also, characteristics of a terminal may include memory capacity, display characteristics, and codec information installed in the terminal, which are related to the terminal's buffering capability. Also, media characteristics may include a bandwidth required for media transmission, characteristics of a codec, and a screen size.

FIG. 2 is a diagram of a method of providing a service via a connection between an authentication server 240 and a media transforming apparatus 250 while changing a terminal, according to an embodiment of the present invention. When a user changes a first terminal 210 to a second terminal 220 in operation S220 while the user is receiving media in operation S210 by using the first terminal 210, an authentication process is performed by using characteristic information of the second terminal 220 in operations S230 and S240. Then, the authentication server 240 approves a connection of the second terminal 220 in operation S250, and transmits the characteristic information of the second terminal 220 stored in a user DB to the media transforming apparatus 250 in operation S260. Next, the media transforming apparatus 250 receives the media from an application server 260 in operation S270, transforms the media according to the characteristic information of the second terminal 220 in operation S280, and then transmits the media to the second terminal 220 in operation S290.

FIG. 3 is a diagram of a method of providing a service via a connection between network equipment and a media transforming apparatus 350 according to a change of an access network, while moving a terminal, according to an embodiment of the present invention. When an access network changes from a first network connecting apparatus 320 to a second network connecting apparatus 330 while a terminal 310 uses the first network connecting apparatus 320 in operation S310 and receives media provided by an application server 360 in operation S320, an authentication process is performed in operations S330 and S340 on the terminal 310 by using characteristic information of the terminal 310, and then the second network connecting apparatus 330 extracts the characteristic information of the terminal 310 in operation S360. Unlike the method of FIG. 2 where a terminal is changed, an access network to which the terminal 310 is connected is changed in the method of FIG. 3, and thus not only the characteristic information of the terminal 310 but also characteristic information of a new access network is transmitted. Accordingly, when the characteristic information of the second network connecting apparatus 330 and the terminal 310 is transmitted to the media transforming apparatus 350 in operation S370, the media transforming apparatus 350 transforms characteristics of the media that is transmitted from the application server 360 to the media transforming apparatus 350 in operation S380, according to the characteristic information of the second network connecting apparatus 330 in operation S380, and then transmits the media to the terminal 310 in operation S395.

FIG. 4 is a diagram of a method of transforming media in a network connecting apparatus 430 while changing a terminal, according to an embodiment of the present invention. In the current embodiment, a media transforming apparatus is included in the network connecting apparatus 430. When a user changes a first terminal 410 to a second terminal 420 in operation S420 while receiving media by using the first terminal 410 in operation S410, an authentication process is performed by using characteristic information of the second terminal 420 in operations S430 through S450. Here, the media transforming apparatus included in the network connecting apparatus 430 extracts and stores the characteristic information of the second terminal 420 in operation S460, changes characteristics of the media that is being received in operation S470 according to the characteristic information of the second terminal 420 in operation S480, and then transmits the media to the second terminal 420 in operation S490.

According to the method and system of providing a multimedia service in an

IP network of the present invention, when only a terminal changes and an access network does not change, or when only an access network changes and a terminal does not change, a network automatically recognizes characteristics of the terminal and the access network and automatically transforms media according to the recognized characteristics. Accordingly, a multimedia service without quality deterioration is received, and moreover, a service that can satisfy characteristics (capacity, size of display, etc.) of a terminal of a user and a corresponding service level agreement (SLA) of the user are provided in various terminal environments.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While this invention has been particularly shown and described with reference to preferred embodiments thereof, it will be understood by those of ordinary skill in the art that various changes in form and details may be made therein without departing from the spirit and scope of the invention as defined by the appended claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of providing a multimedia service in an information provider (IP) network, wherein the method is performed by a system of providing an IP-based mobile service, the method comprising:
detecting whether a user, who is being provided with the multimedia service, changes from a first terminal to a second terminal;
obtaining characteristic information of the second terminal; and
providing the multimedia service after transforming the multimedia service according to the obtained characteristic information.

2. The method of claim 1, wherein the detecting comprises:
obtaining the characteristic information of the second terminal, wherein the obtaining is performed by an authentication server; and
approving a connection after authenticating the second terminal based on the characteristic information.

3. The method of claim 1, wherein the obtaining comprises obtaining the characteristic information based on an intrinsic identification (ID) including a media access control (MAC) address and an ENUM of the second terminal.

4. The method of claim 3, wherein in the obtaining, the characteristic information is obtained from an authentication server authenticating the second terminal, or an apparatus that connects the second terminal to the IP network.

5. A method of providing a multimedia service in an IP network, wherein the method is performed by a system of providing an IP-based mobile service, the method comprising:
detecting whether a user, who is being provided with the multimedia service to a terminal via a first access network, is connecting to a second access network;
obtaining characteristic information of the terminal and the second access network; and
providing the multimedia service by transforming the multimedia service according to the characteristic information.

6. The method of claim 5, wherein the detecting comprises:
obtaining the characteristic information of the terminal, wherein the obtaining is performed by an authentication server; and
approving a connection to the second access network after authenticating the second access network based on the information.

7. The method of claim 5, wherein the obtaining comprises obtaining the characteristic information of the terminal based on an intrinsic ID comprising a MAC address and an ENUM of the terminal.

8. The method of claim 7, wherein in the obtaining, the characteristic information of the terminal is obtained by an authentication server that authenticates the terminal or an apparatus for connecting the terminal to the IP network.

9. The method of claim 5, wherein the characteristic information of the second access network comprises resource information and transmission characteristics of the second access network.

10. A system of providing a multimedia service in an IP-based network, the system comprising:
a terminal which receives the multimedia service;
a connecting apparatus which connects the terminal and the IP-based network; and
a transforming apparatus which, when the terminal or an access network changes, transforms and then provides the multimedia service according to characteristic information of the changed terminal or access network.

11. The system of claim 10, wherein when the terminal changes, the transforming apparatus recognizes the characteristic information of the changed terminal after authenticating the changed terminal, transforms media characteristics, and then transmits the multimedia service to the changed terminal.

12. The system of claim 10, wherein when the access network changes while the terminal does not change, the connecting apparatus enables an authentication server to perform new authentication and provides the characteristic information of the terminal and the changed access network to the transforming apparatus, and then the transforming apparatus transmits the multimedia service to the terminal after transforming media characteristics according to the characteristic information of the terminal and the changed access network.

13. The system of claim 10, wherein the characteristic information of the access network comprises resource information and transmission characteristics of the access network.

14. The system of claim 10, wherein the characteristic information of the terminal is obtained based on an intrinsic ID comprising a MAC address and an ENUM of the terminal.

15. The system of claim 11, wherein the characteristic information of the terminal is obtained based on an intrinsic ID comprising an MAC address and an ENUM of the terminal.
